(19) United States
(12) Patent Application Publication
(10) Pub. No.: US 2007/0124608 A1
(43) Pub. Date: May 31, 2007

(54) System and method for managing power of networked devices

(75) Inventors: Kenneth Knowlson, Portland, OR (US); Shailendra Sinha, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/292,161

(22) Filed: Nov. 30, 2005

(51) Int. Cl. G06F 1/26

(52) U.S. Cl. 713/300

(57) ABSTRACT

Embodiments of this invention provide a system and method for managing the power of networked devices. A power managed device in accordance with embodiments of this invention, include a network power manager connected to a network interface and a local power manager. The network power manager transmits event notifications to a control point device. An event notification indicates a current, recent, and/or pending power state of the power managed device. In certain applications, the network power manager transmits power management information to a subscribing control point device. The power management information allows the control point device to direct the power managed device to operate at a certain power level.

### TECHNICAL FIELD

Embodiments of this invention relate to power managed devices and, in particular, to a system and method for managing power of networked devices.

### BACKGROUND

Today, users are connecting an increasing number of devices to networks. It is now commonplace for users to have computer networks in their homes to allow data transfer between multiple computers and sharing of an Internet connection.

With an explosion of digital media and an increase in archiving of digital media on home computers, users now want systems which allow them to connect other devices, e.g. their televisions, to the network in order to share data between these traditionally disconnected devices. By connecting a television to the network, the user can, for example, view movies stored on their personal computers. By connecting other local devices and systems (e.g., an alarm system) to the network, the user can transfer data back and forth between these other devices and systems and their networked computers, creating what is sometimes referred to as a smart home.

Conventionally, systems which allow a user to transfer data between networked devices require that the transmitting and receiving devices are in a fully powered state. For example, to view a movie on a living room television, a computer located in an upstairs bedroom storing the movie must be awake, i.e. in a fully powered state. If the computer is in a reduced power state, e.g. sleep or hibernate, the computer may not be able to receive the request for the data and/or transmit the data to the television. In conventional systems, when the computer is in a reduced power state, a user manually wakes the computer to a full power state before playing the movie on the television. This is often inconvenient when the computer and television are located in different rooms. Moreover, although a user may be able to access the file theoretically via the network connection, in conventional systems, the user cannot allow the computer (or whichever device provides the desired data) to enter into a reduced power state. However, maintaining all the devices which may provide desired data at a fully powered state unnecessarily consumes energy, especially when access to the data is sporadic.

To allow networked devices to wake another networked device, conventional solutions require custom hardware and often a user un-friendly configuration of software and/or firmware. In addition, conventional solutions do not allow a device simply to monitor a power state of another networked device. Therefore, conventional solutions do not allow devices to decide whether to execute operations depending on the power state of the other devices without waking the other devices.

Thus, what is needed is an improved system and method for managing power of networked devices.

### BRIEF DESCRIPTION OF THE DRAWINGS

FIG. 1A is a block diagram of a network scheme including networked devices in accordance with one embodiment of this invention.

FIG. 1B is a block diagram illustrating components of the networked devices shown in FIG. 1A.

FIG. 2 is a block diagram of a device including a network power manager in accordance with one embodiment of this invention.

FIG. 3 is a block diagram of a device which includes a control point in accordance with one embodiment of this invention.

FIG. 4A is a flow chart of communications between a network power manager and a control point in accordance with one embodiment of this invention.

FIG. 4B is a flow diagram of communications between the network power manager and the control point following the communications shown in FIG. 4A in accordance with one embodiment of this invention.

### DETAILED DESCRIPTION

Embodiments of this invention include a system and method for managing power of networked devices. Managing power of networked devices includes monitoring powers state of networked devices including, but not limited to, tracking a power state of a networked device. Managing power of networked devices also includes managing power states of networked devices, including but not limited to directing a networked device to operate at a certain power state. Certain embodiments of this invention allow one (control point) device on the network, e.g. a digital media access (DMA), to receive power state information indicating a current, recent, and/or pending power state of another (network power managed) device on the network, e.g. a desktop computer. In one application, based on this information, the DMA attempts to retrieve data from an alternative source when the desktop computer is in a reduced power state. Certain embodiments of this invention also allow the control device on the network to direct the network power managed device on the network to operate at a certain power state. For example, in one application, the DMA wakes the desktop computer from the reduced power state in order to retrieve data from the desktop computer.

Powered managed networked devices in accordance with embodiments of this invention include, for example, a computing device, e.g. a server computer, a laptop, and desktop, as well as computer peripherals, e.g. a printer. Powered managed networked devices in accordance with embodiments of this invention also include, for example, consumer devices, e.g. a camera having a network interface, a telephone, a mobile device (e.g. a personal digital assistant (PDA) or a mobile phone). Powered managed networked devices in accordance with embodiments of this invention further include, for example, monitoring devices, e.g. a fire alarm, a security camera system, and home health equipment (e.g. a medical monitoring device), as well as other home control equipment.

Control point devices in accordance with embodiments of this invention include home networked devices such as a set-top box, a computer, a mobile device, a digital media adapter (DMA), and media players, e.g. equipment that plays Digital Versatile Discs (DVDs), including High Definition DVDs, and media formats such as Moving Picture Experts Group Layer-3 (MP3), Windows Media Video (WMV), Windows Media Audio (WMA), H.264, and Advanced Audio Coding (AAC), for example.

The following provides variation and examples of various aspects of embodiments of the present invention. It will be appreciated that the following variations and examples are not intended to be exhaustive or to limit the embodiment of the present invention to the precise forms disclosed. These variations and examples are to provide further understanding of embodiments of the invention.

In the following detailed description, numerous specific details are set forth in order to provide a thorough understanding of embodiments of this invention. However, it will be apparent to one of ordinary skill in the art that these specific details need not be used to practice embodiments of this invention. In other circumstances, well known structures, materials or processes have not been shown and described in detail in order not to obscure unnecessarily embodiments of this invention.

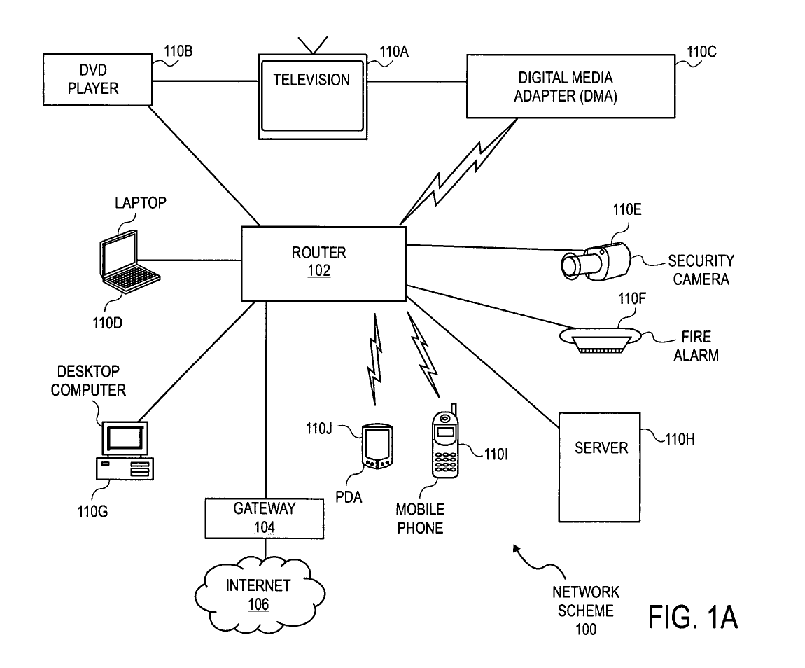

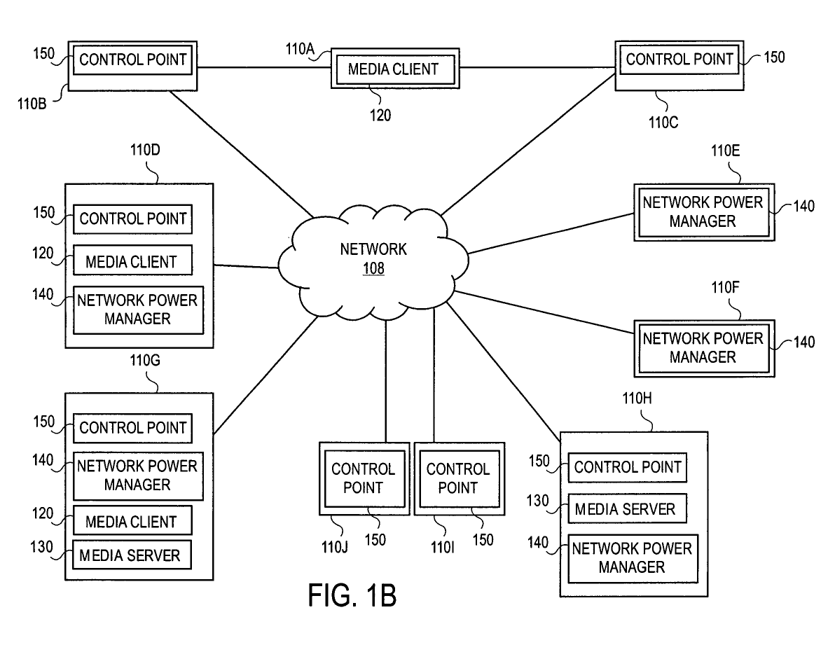

FIG. 1A is a block diagram of a network scheme including networked devices in accordance with one embodiment of this invention. In FIG. 1A, network scheme 100 includes router 102, gateway 104, internet 106 and devices 110A-J.

Router 102 may be, for example, an access point. In certain embodiments, router 102 is a single integrated device. Router 102 is connected to gateway 104 which may be, for example, a broadband modem. Together, router 102 and gateway 104 provide devices 110A-J connected, directly or indirectly, to router 102 with access to another network (e.g. Internet 106). In one application, network scheme 100 represents a home local area network.

In FIG. 1A, devices 110A-J include a display (e.g. television 110A), a media player (e.g. digital video disc (DVD) player 110B), digital media adapter (DMA) 110C, personal computers (e.g. laptop 110D and desktop computer 110G), a camera with a network interface (e.g. security camera 110E), an alarm (e.g. fire alarm 110F), server computer 110H, and mobile devices (e.g. mobile phone 110I and personal digital assistant (PDA) 110J). It shall be appreciated that a network scheme in accordance with embodiments of this invention may include other networked devices not shown in FIG. 1A such as, for example, a printer.

Devices 110A-J are connected to router 102 wirelessly or using wires. For example, DMA 100C is connected to router 102 wirelessly, e.g. using Bluetooth, e.g. the Bluetooth specification 2.0, published Nov. 4, 2004, or the Institute of Electrical and Electronics Engineers (IEEE) 802 standards, e.g. IEEE std. 802.11g-2003, published Jun. 27, 2003, or radio communications techniques, e.g. ultra-wide band (UWB). In FIG. 1A, desktop computer 110G is connected to router 102 using wires, e.g. Category 5 (CAT 5) cables for use with Ethernet technology or power lines for use with HomePlug AV (HPAV)) technology.

Devices 110A-J are powered devices. Some of devices 110A-J support two power states, e.g. on and off. For example, security camera 110E and fire alarm 110F each supports two power states, on and off. However, even when a powered device supports only two power states, such a device includes a local (hardware and/or software) power manager that monitors the device's power supply. This local power manager can alert a user, for example, when the device reaches a threshold power level while in the powered state. For example, the fire alarm may beep when its battery power has reached a certain level, i.e. when it is low on batteries.

Some of devices 110A-J support more than two powers states (e.g. wake, sleep, soft off, and low battery). Sleep and soft off are each power states in which certain subsystems are powered down in order to reduce power consumption.

The sleep state is a reduced power consumption state from which work can be resumed without restarting the sleeping device's operating system. In the sleeping state (also referred to as the sleep state), certain subsystems are powered down, e.g. fans, video subsystems, and hard drive subsystems. The soft off state is a reduced power consumption state from which the soft off device's operating system restarts in order to return to a wake state.

In one application, each of the personal computers, i.e. laptop 110D and desktop computer 110G, include a local power manager which manages the power of the computer in accordance with the Advance Configuration and Power Interface (ACPI) specification, e.g. the ACPI standard, revision 3.0 published Sep. 2, 2004.

The ACPI specification was developed to establish industry common interfaces enabling robust operating system (OS)-directed motherboard device configuration and power management of individual devices as well as entire systems. A device (or system) which operates in accordance with the ACPI specification has four different global system power states, i.e. working, sleeping, soft off and mechanical off.

In the working state (also referred to as the wake state), the computer is running normally, i.e. the computer is awake.

In the sleeping state, a device may be in one of several substates, including a standby state and a hibernate state. In the standby state (sometimes referred to as S3), all system context is lost except system memory. In the hibernate state (sometimes referred to as S4), the operating system writes all system context to a file on non-volatile storage media. A system in the hibernate state (S4) has a longer wake latency than the same system in the standby state (S3).

In the mechanical off state, no power is consumed by the device except for a real-time clock. In this state, it is safe to disassemble the device.

In the first two global states (i.e. working and sleeping), the device's OS is not powered down and therefore a device in the first two states does not require a restart of the device's OS to fully function. On the other hand, each of the latter two global states (i.e. soft off and mechanical off) requires a restart of the device's OS to fully function. A summary of the power states defined by the ACPI specification is shown in Table 1, below:

TABLE 1

| | | | | | Safe to | |
|---|---|---|---|---|---|---|
| | Software | | Power | OS restart | disassemble | Exit state |
| Global system state | runs | Latency | consumption | required | computer | electronically |
| G0 Working | Yes | 0 | Large | No | No | Yes |
| G1 Sleeping | No | >0, varies | Smaller | No | No | Yes |
| | | with sleep | | | | |
| | | state | | | | |
| G2/S5 Soft Off | No | Long | Very near 0 | Yes | No | Yes |
| G3 Mechanical Off | No | Long | RTC battery | Yes | Yes | No |

Accordingly, each of the personal computers, laptop 110D and desktop computer 110G, intelligently transitions between system power states to reduce system power consumption, heat, and/or noise, for example. These computers return to the normal running power state (i.e. working) with limited impact to the responsiveness of the overall system. Transitioning between power states when a computer is not in active use reduces noise, a particularly significant concern in residential environments. Additionally, for battery powered devices supporting ACPI, such as laptops, transitioning between power states when the battery powered device is not in active use reduces power consumption and accordingly extends battery life.

Certain battery powered devices that do not support ACPI have other features which also allow the device to extend battery life. For example, mobile phone 110I and/or PDA 110J are each battery powered devices which may have features which turn down or shut off the mobile phone's or PDA's display brightness after a period of inactivity.

Each of the devices 110A-J includes one or more components which allow the device to communicate with some of the other devices 110A-J in the network. Depending on which components are included in a device, the device may receive and/or transmit to the other networked devices 110A-J data (e.g. media data or sensor data) and/or power information (e.g. power state information or power management information). The structure and functions of these components is further understood with reference to FIG. 1B.

FIG. 1B is a block diagram illustrating components of the networked devices shown in FIG. 1A. In FIG. 1B, each device 110A-J is represented by a node 110A-J connected to a network 108. Each node includes one or more components which communicate with other nodes in the network. These components include media client 120, media server 130, network power manager 140, and control point 150. Each of these components may be implemented using software and/or hardware.

Media client 120 receives media data from media server 130. Although in the embodiment presently described, media data is transmitted between media client 120 and media server 130 for illustrative purposes, it shall be appreciated that any data may be transmitted between client 120 and server 130 in accordance with embodiments of this invention. For example, non-media files such as documents may be transmitted between client 120 and server 130. In certain applications, the media data includes music (e.g. MPEG-1 Audio Layer 3, or MP3, files), video (e.g. DVD files), and other multi-media data, e.g. digital photograph slide show files. In use, a device including client 120 receives data from a device including server 130 when server 130 is in a non-reduced power state.

Devices on network 108 which do not include client 120 may also provide data to other devices in the network. For example, security camera 110E and fire alarm 110F may provide security video footage or fire sensor data respectively to other devices on the network. The ability of the other devices on the network to receive this video security footage or this fire sensor data depends on the power state of the security camera or the fire alarm, respectively.

Accordingly, the ability of receiving devices on network 108 to receive data is dependent on whether the transmitting devices providing the data are in a reduced or non-reduced power state. To allow users to be informed of power states of various devices on a network and, in some embodiments, provide constant or near constant availability of the data to the user, certain devices on the network include network power manager 140.

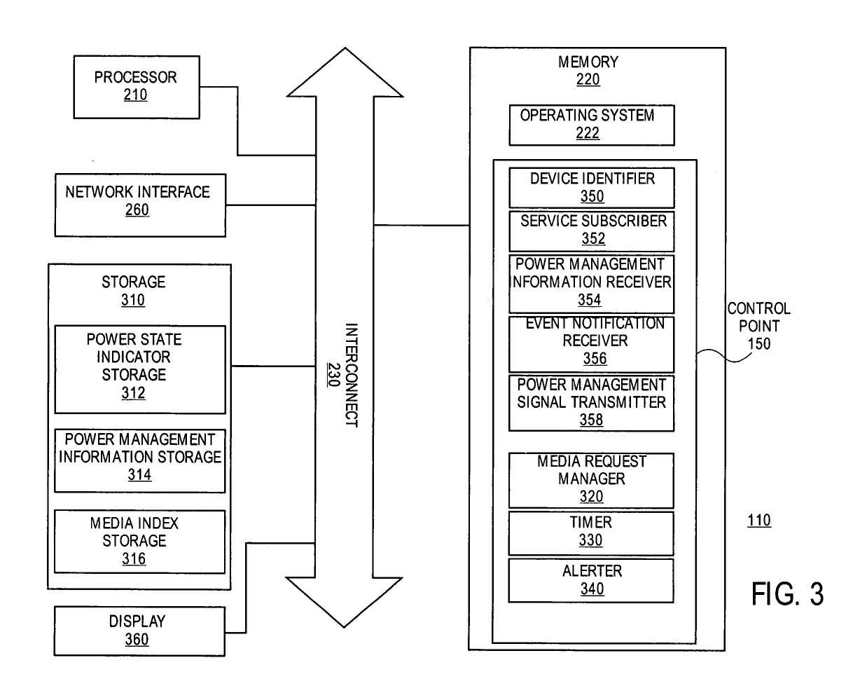

Network power manager 140 transmits event notifications to a control point 150 which has subscribed to a power management service running on the device including network power manager 140. In one exemplary embodiment, the power management service is a Universal Plug and Play (UPnP™) based service. That is, in one embodiment, the power management service is structured based on the UPnP™ architecture. The UPnP™ architecture offers pervasive peer-to-peer network connectivity of personal computers of all form factors, intelligent appliances, and wireless devices. The UPnP™ architecture leverages Transmission Control Protocol/Internet Protocol (TCP/IP) and the Internet to enable seamless proximity networking in addition to control and data transfer among networked devices in environments such the home, office, and locations in between. When the power management service is a UPnP based service, control point 150 is a UPnP based control point. As used herein, however, the term control point generally refers to any entity which subscribes to the network power management service. A control point is described in further detail with respect to FIG. 3.

The power management service described herein is controlled by network power manager 140. Network power manager 140 transmits event notifications to control points subscribed to the power management service. An event notification is a signal which indicates a current, recent, and/or pending power state of the power managed device, i.e. the device which includes network power manager 140. For example, the event notification may indicate that the power managed device is in a low power state, recently resumed a wake state, or is about to enter into a sleep state, for example.

In certain applications, network power manager 140 also transmits power management information to a subscribing control point. The power management information allows the control point device (i.e. the device which includes the control point) to direct the network power managed device to operate at a certain power level, as will be described in further detail below.

As shown in FIG. 1B, control points are located in various devices on the network. For example, as illustrated in FIGS. 1A and 1B, devices such as the desktop computer, the laptop, the DVD player, the digital media adapter, the PDA, the mobile phone and the server computer, each includes control points to receive event notifications from power managed devices, e.g. the fire alarm, the security system, the laptop, the personal computer and the server computer. In certain applications, control points are located in devices which are not power managed. These control points may also monitor the power states and share this information with other devices, including power managed devices.

In FIG. 1B, each node in the network 108 includes one or more of the components described above, i.e., a client, a server, a network power manager, and a control point. In a typical network arrangement in accordance with embodiments of this invention, only one device in the network includes a network power manager, e.g. DMA 110C. However, in other network arrangements in accordance with embodiments of this invention, more than one node includes a network power manager, such as shown in FIG. 1B.

In FIG. 1B, node 110A (representing television device 110A) includes a client from which data requests originate. Television device 110A receives data from a server in another node in network 108, e.g. the server in desktop computer 110G or the server in server computer 110H.

Nodes 110B (representing the DVD player 110B) and 110C (representing DMA 110C) each include a control point, which receives event notifications from certain network power managers in the other nodes on network 108. Both the DVD player and the DMA 110C are accordingly informed of power states of certain devices on the network.

Node 110D (representing laptop 110D) includes a media client, a network power manager, and a control point. The client in node 110D requests a server for data (e.g. a music file to play over the laptop speakers). Because node 110D also includes a control point, node 110D also receives event notifications over the network. In addition, because node 110D includes a network power manager, node 110D also transmits event notifications to control points in other nodes to notify those control points of a current and/or pending power state of laptop 110D. Therefore, when laptop 110D enters into a hibernation state, the other nodes in the network with control points subscribed to the power management service running on the laptop are informed of the hibernation state.

Nodes 110E and 110F (representing security camera 110E and fire alarm 110F, respectively) each include a network power manager as well. Therefore, an event notification may also come from node 110E or node 110F. The network power manager in each of the nodes 110E and 110F may transmit an event notification indicating that the device is low on batteries, for example. In one application, the network power manager also indicates in the event notification that the device will shut off in approximately a certain amount of time if the batteries are not replaced.

Node 110G (representing desktop computer 110G) includes a client, a server, a network power manager, and a control point. The desktop computer receives data from a media server such as the server in server computer 110H, and serves data to another media client such as the media client in television 110A. The desktop computer also transmits event notifications to indicate its current and/or pending power states to other nodes in the network and also receives event notifications from other nodes in the network.

For example, in one application, using the client in desktop computer 110G, desktop computer 110G receives music data from a server in server computer 110H. Desktop computer 110G may then play the music data on speakers attached to the desktop computer. Using the server in desktop computer 110G, desktop computer 110G transmits, for example, video data to a client in television 110A via DMA 110C and access point 102. Television 110A may then display the video data on a screen. Using the network power manager in desktop computer 110G, a user can store the video data on the computer, allow the computer to enter into a reduced power state (e.g. sleep), and retrieve the data remotely without manually waking the computer.

To accomplish this, the desktop computer network power manager provides event notifications to control points in other nodes in network 108 which have subscribed to a power management service running on the desktop computer and controlled by the desktop computer network power manager. These event notifications indicate to the subscribed control points a current and/or pending power state of desktop computer 110G.

In one application, for example, using the network power manager in desktop computer 110G, desktop computer 110G transmits power management information, via access point 102, to a control point in DMA 110C. Desktop computer 110G then transmits power state information using an event notification to the DMA control point. The DMA control point uses the power management information and the power state information to facilitate on-demand viewing of the media data on television 110A. For example, when the power state information indicates that the computer is in a reduced power state, the DMA control point directs the computer to wake before retrieving the data. When there is a delay in retrieving the data while the computer wakes, the DMA may be configured to notify the user to wait while the computer wakes. For example, the DMA may be configured to display a “Please wait” visual to the user via the television screen. In certain configurations, when the power state information indicates that the computer is in a reduced power state, the DMA control point retrieves the requested data from another server, e.g. the server in server computer 110H, instead of from the server in desktop computer 110G.

The control point in desktop computer 110G also uses power management information and power state information sent from network power managers on other nodes in the network. For example, in one application, the desktop computer control point uses power state information sent from fire alarm 110F to alert a user of a power state of the alarm, e.g. low batteries. In one application, the computer alerts the user via a user interface displayed on a computer monitor. The user may be informed, for example, that the batteries in the fire alarm need replacement.

Node 110H (representing server computer 110H) includes a server, a network power manager, and a control point. Accordingly, node 110H provides data to a client on another node, transmits event notifications to control points in other nodes, and receives event notifications from network power managers in other nodes.

Node 110I and 110J (representing mobile phone 110I and PDA 110J, respectively) each include a control point. Accordingly, each receives power state information, and, in certain instances, power management information from network power managers in other devices in the network. Therefore, mobile phone 110I and PDA 110J can each direct a device on the network to operate at a certain power state.

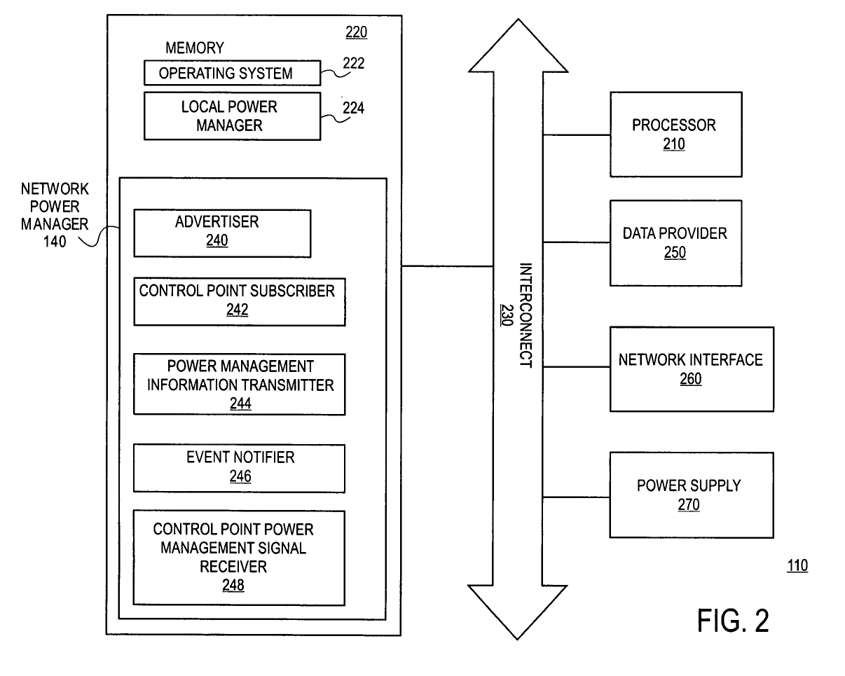

FIG. 2 is a block diagram of a device including a network power manager in accordance with one embodiment of this invention. In FIG. 2, device 110 includes processor 210, memory 220, interconnect 230, data provider 250, network interface 260, and power supply 270. The processor, memory, data provider, network interface and power supply all communicate with each other via interconnect 230. To avoid unnecessarily obscuring the description of embodiments of the present invention, interconnect 230 is shown to transfer both data and power between the components of the device, although the data signal and the power signal may, in certain embodiments, transferred using different interconnects.

In certain applications, when device 110 is a personal computer, data provider 250 may be, for example, a storage medium or an interface to a storage system. In certain applications, when device 110 is an alarm (e.g. a fire alarm), data provider 250 may be an alarm sensor, for example. In certain applications, when device 110 is a camera (e.g. a security camera), data provider 250 may be a camera lens, for example.

Processor 210 executes instructions stored in memory 220. Memory 220 may be non-volatile or volatile memory. Memory 220 includes operating system 222, local power manager 224, and network power manager 140. Operating system 222 includes basic system instructions well known in the arts.

Local power manager 224 manages power supplied to the other components of device 110 by power supply 270. In applications in which the network power managed device is the security camera or the fire alarm, the local power manager may manage the power by monitoring the battery levels of the security camera or fire alarm, for example. In applications in which the network power managed device is the laptop or the personal computer, the local power manager may manage the power by switching the device between multiple power states depending on idle time, for example.

Network power manager 140 includes components that notify other devices in the network of a current and/or pending power state of the network power managed device. In some applications, network power manager 140 also includes components which allow other devices in the network to direct the network power managed device to operate at certain power levels.

In one embodiment, network power manager 140 includes advertiser 240, control point subscriber 242, power management information transmitter 244, event notifier 246, and control point power management signal receiver 248. In one application, when device 110 is a personal computer, network power manager advertiser 240 in network power manager 140, using network interface 260, advertises to one or more control points, connected to the personal computer via the network, that the personal computer is running a network power management service. As mentioned above, in one exemplary embodiment, the network power management service is a UPnP based service. Control point subscriber 242 subscribes at least one of those control points to the service to allow the control point to receive event notifications from the network power managed device, as suggested above.

Power management information transmitter 244 transmits to the subscribing control point information relevant to network power management of power managed device 110. This information may include, for example, a number of network interfaces on device 110 (e.g. three network interface cards (NICs), a type of each network interfaces (e.g. wired, wireless, 1394, or USB), an IP addresses configured on each network interfaces, a wake up pattern configured for each network interfaces, and a unique device identifier for that device (e.g., a media access control (MAC) address).

When the network power managed device shown in FIG. 2 is about to enter a different power state (e.g. is about to go to sleep), event notifier 246 sends an event notification indicating the network power managed device's pending power state. In one application when the power management service is UPnP based, the event notifier then broadcasts a bye-bye message (e.g. a Simple Service Discovery Protocol (SSDP): bye-bye message) to the devices in the network. This bye-bye message ensures that the network power managed device is not inadvertently woken by other messages transmitted on the network.

To direct the network power managed device to operate at a different power state, a subscribed control point uses the power management information previously received from the power managed device to issue a power management signal to the power managed device.

For example, in one application, while a power managed device is asleep, a subscribed control point issues a wake up signal in order to retrieve data from the network power managed device. In one application, the wake up signal has a wake up pattern configured for a specific NIC used to connect the power managed device to the network (e.g. using a MAC address of a wireless NIC). The wake up pattern allows the wake up signal to be targeted towards the specific NIC, and therefore towards a specific device.

The wake up signal is received at the control point power management signal receiver. In the present example, a corresponding wake up signal is then transmitted from the network power manager to local power manager 224. The local power manager wakes up the network power managed device, increasing the amount of power drawn from the power supply.

In certain applications, the networked power manager may not include or utilize power management information transmitter 244 and control point power management signal receiver 248. For example, in an application in which a device does not use protocols such as protocols based on the APCI specification which allow the device's power state to be electronically altered, transmission of power management information is unnecessary. For example, transmission of power management information is unnecessary when the power managed device is the battery powered fire alarm or security camera described above. Therefore, use of the power management information transmitter and control point power management signal receiver is unnecessary. However, using advertiser 240, control point subscriber 242, and event notifier 246, the power managed device may still inform subscribed control points when the device is low on batteries, preparing to shut off, or being shutdown, for example. Although a user may not be able to wake up or change the fire alarm's or security camera's power state using the network power manager in such an application, the user is still informed of the power state and can accordingly replace batteries or check the device to ensure its proper functioning.

FIG. 3 is a block diagram of a device which includes a control point in accordance with one embodiment of this invention. In FIG. 3, a device 110 includes processor 210, network interface 260, storage 310, display 360, interconnect 230 and memory 220. Processor 210, network interface 260, storage 310, display 360 and memory 220 are connected via interconnect 230. As in FIG. 2, processor 210 executes instructions stored in memory 220.

In FIG. 3, memory 220 includes operating system 222 and control point 150. Control point 150 includes device identifier 350, service subscriber 352, power management information receiver 354, event notification receiver 356, power management signal transmitter 358, media request manager 320, timer 330, and alerter 340, each of which may be composed of hardware and/or software. Storage 310 includes power state indicator storage 312, power management information storage 314, and media index storage 316, each of which may be composed of hardware and/or software.

In use, device identifier 350 identifies a network power managed device, e.g. the device shown in FIG. 2. Service subscriber 252 subscribes the control point device to a network power management service (e.g. the UPnP service) advertised by the network power managed device to receive event notifications from the network power managed device. Power management information receiver 354 receives information from the network power managed device which allows the control point device to direct the network power managed device to operate at a certain power state. The power management information is stored in power management information storage 314 in storage 110. When the network power managed device enters a certain power stage, the network power managed device transmits an event notification received at notification receiver 356 in the control point device. The control point device stores an indication of the network power managed device's power state in power state indicator storage 312 in storage 310 for later use. For example, in one embodiment, the control point device stores a bit in a lookup table which maps power managed devices to various power states.

For example, in one application, the control point device shown in FIG. 3 is DMA 110C and the network power managed device is desktop computer 110G. Device identifier 350 in the DMA identifies desktop computer 110G. Service subscriber 252 in the DMA subscribes the DMA to a network power management service advertised by desktop computer 110G. Power management information receiver 354 in the DMA receives information from the desktop computer which allows the DMA to direct the desktop computer to operate at a certain power state. This information is stored in power management information storage 314 in the DMA. When the desktop computer enters a certain power stage, e.g. sleep, the desktop computer transmits an event notification received at event notification receiver 356 in the DMA. The DMA stores an indication of the laptop's power state in power state indicator storage 312 in storage 310 for later use.

In one application, the control point device receives media requests. For example, in one application, the DMA receives a media request from a user using a device such as television 110A. The request is received at media request manager 320. When the requested data is located on the sleeping desktop computer, media request manager 320 directs power management signal transmitter 358 to use the information stored in power management information storage 314 to direct the desktop computer to operate at a wake power state.

In certain configurations, when media request manager 320 determines that the desktop computer is asleep, the media request manager instead accesses media index storage 316 to determine if another device on the network (e.g. server computer 110H) has the requested media.

In certain applications, when power management signal transmitter 358 transmits the signal directing the desktop computer to operate at a certain power state, control point 150 initiates timer 230. If the desktop computer does not respond within a certain amount of time, the timer times out to indicate that the desktop computer may have left the network.

In certain applications, the timer is used by the media request manager to facilitate retrieval of the requested data. For example, the timer may countdown an amount of time the sleeping device is expected to take to wake. After this time has elapsed, the media request manager transmits a request for the data to now awake device. This countdown may also be displayed to the user to let the user know how long the user will have to wait for the data.

In certain configurations, control point 150 also includes alerter 340. In certain applications, the alerter alerts the user of the power state of a network power managed device when an event notification from the network power managed device is received at event notification receiver 356. In certain applications, the alerter uses display 360 to inform a user of the power state of the network power managed device. Display 360 may display to the user availability of the power managed device, e.g. via a listing on a user interface of devices which are available for immediate data access based on the received event notification. In certain applications, alerter 340 uses network interface 260 to transmit an alert to another system, e.g. a pager, PDA, mobile phone, email system, or instant messaging system. For example, if security camera 110E or fire alarm 110F is low on batteries, alerter 340 may be configured to send the user an email to alert the user of the power state of the security camera 110E or fire alarm 110F.

In certain applications, the control point device may not include or use power management information receiver 354 and power management signal transmitter 358. For example, when a network power managed device with which the control point device is communicating lacks protocols that allow the network power managed device's power state to be electronically altered, e.g. the security camera or the fire alarm as discussed above, the network power managed device will not transmit power management information. Accordingly, power management information receiver 354 in the control point device may not be used in that application. However, in certain applications, power management information receiver 354 may still be included in the control point to enable the control point to receive power management information from other devices in the network.

For example, in one application, the control point device of FIG. 3 receives event notifications from several devices on the network, including event notifications from a laptop and an alarm. When the control point device subscribes to the network power management service running on the laptop, the control point device receives power management information from the laptop at power management information receiver 354. Later, the control point device transmits power management signals using power management signal transmitter 358 to the laptop. When the control point device subscribes to the network power management service running on the alarm, however, the control point device does not receive power management information from the alarm. Accordingly, the control point device will not later transmit power management signals to the alarm.

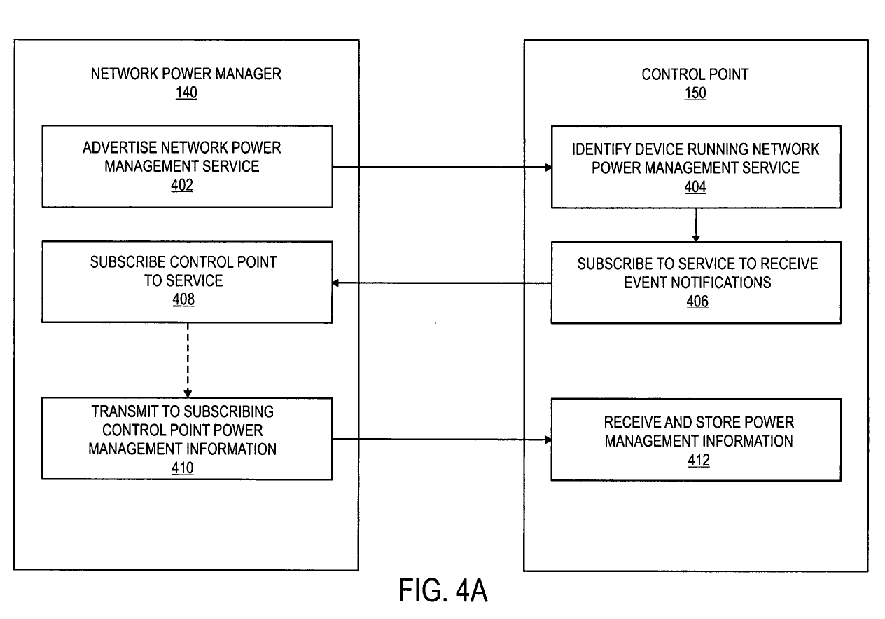

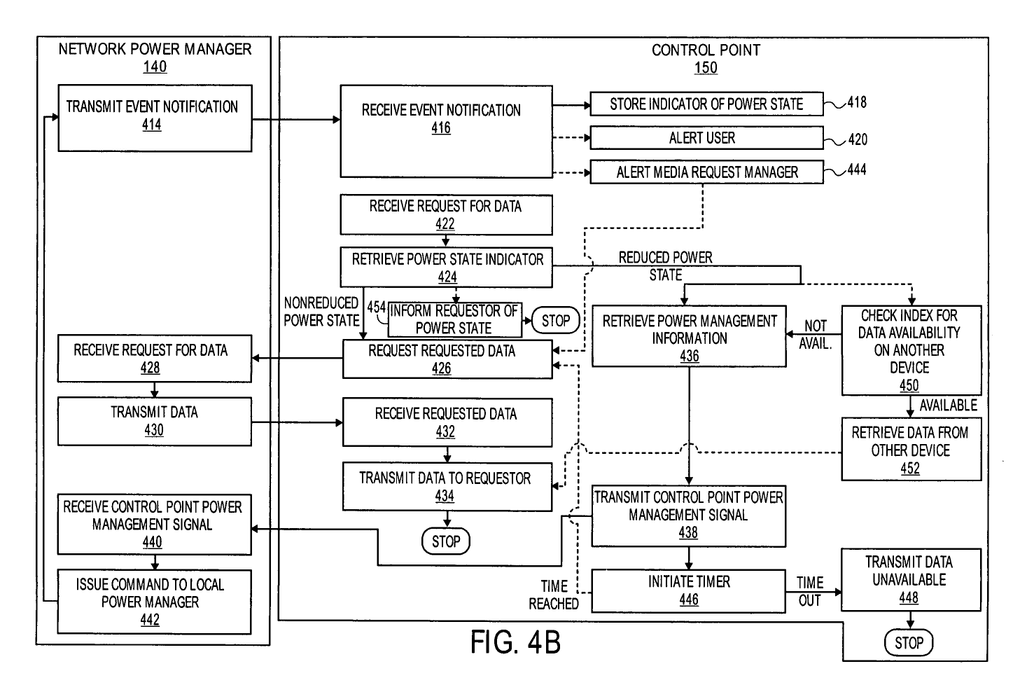

FIG. 4A is a flow chart of communications between a network power manager and a control point in accordance with one embodiment of this invention. Specifically, FIG. 4A illustrates a subscription process, i.e. a process of subscribing a control point to a power management service running on a network power managed device.

At 402, network power manager 140 advertises the network power management service. The advertisement occurs each time the network power managed device connects to the network 108. For example, when the network power managed device wirelessly connects to the network 108, each time the device re-connects to network 108 (e.g. when the device re-enters the network's wireless signal range), network power manager 140 in the device advertises the network power management service. In embodiments in which the service is a UPnP service, this advertisement occurs after the power managed device broadcasts an SSDP: alive message to inform listening control points of the device's entry into the network. In those embodiments, while the power managed device is in the network, the device continues to transmits an SSDP:keep-alive message regularly to indicate that the device is accessible. If a control point does not receive the SSDP:keep-alive message within a stipulated time (e.g. 30 minutes), the control assumes that the device has left the network.

At 404, the control point identifies the network power managed device advertising the network power management service. At 406, the control point subscribes to the service to receive event notifications. At 408, the network power manager subscribes the control point to the service.

In certain applications, the subscription process is complete at 408, such as when the network power manager is included in security camera 110E or fire alarm 110F. In other applications, such as when the network power manager is included in laptop 110D or desktop computer 110G, the subscription process continues to 410.

At 410, the network power manager transmits to subscribing control point 150 power management information to allow the control point to direct the power managed device to operate at a certain state, e.g. wake or sleep. This information may include, for example, a number of NICS in the power managed device, a type of each NIC, an IP address configured for each NIC, a wake up pattern configured for each NIC, and a unique device identifier for the device. At 412, the control point receives and stores the power management information, e.g. in power management information storage 314 in storage 310.

FIG. 4B is a flow diagram of communications between the network power manager and the control point following the communications shown in FIG. 4A in accordance with one embodiment of this invention.

At 414, the network power manager transmits an event notification to the control point. This event notification may be, for example, a notification that the device is about to enter into a reduced power state such as sleep, that the device is in a low power battery state, or that the device has just resumed a certain state, e.g. just entered into a wake state.

In certain applications, the event notification may indicate that the power managed device is switching from one reduced power state to another reduced power state. For example, the power managed device may send an event notification to indicate that the power managed device is switching from a sleep power state, from which the device can quickly wake since the device OS does not have to be restarted, to a soft off state, from which device will take a longer time to wake since the device OS is to be restarted.

To purposes of discussion, the event notification transmitted at 414 indicates that the power managed device is entering a sleep state. At 416, the control point receives this event notification At 418, the control point stores an indicator of the power managed device's power state in power state indicator storage 312.

In certain applications, at 420, the control point alerts a user of the event notification, as previously suggested, using alerter 340. In certain applications, control point 150 may also alert media request manager 320 of the event notification, as will be discussed in further detail below.

At 422, the control point receives a request for data. As previously suggested, this request may be a request for media, e.g. music, DVD, or multimedia files stored on a media server. In certain applications, the request is received via the network interface 260, e.g. from television 110A. In certain applications, the request is received via a user interface displayed on display 360.

At 424, the control point retrieves the power state indicator for the power managed device containing the network power manager. When the power managed device is not in a reduced power state, the control point requests the data from the power managed device at 426. For example, when the power managed device is a laptop which re-connects to the network and transmits an event notification indicating that it is awake, the wake power state is stored in power state indicator storage 312. When the control point retrieves this power state indicator at 424, the control power determines that the laptop is not in a reduced power state. Accordingly, at 426, the control point requests the user requested data from the laptop.

At 428, the laptop receives the request for the data and transmits the data back to the control point at 430. At 432, the control point receives the requested data and, at 434, transmits this data to the requestor, e.g. television 110A or the user interface. After the data is transmitted at 434, the process shown in FIG. 4B stops until another event notification is transmitted at 414 or another request for data is received at 422.

In the present example, however, after the control point retrieves the power state indicator from power state indicator storage 312, the control point determines that the laptop is in a reduced power state, here a sleep state.

In certain applications, the control point recognizes that the request for data received at 422 is directed towards a device for which power management information is stored, e.g. by examining the lookup table mentioned above. Accordingly, at 436, the corresponding power management information is retrieved, including a wake up pattern for the relevant NIC in this example. At 438, control point 150 transmits a control point power management signal directing the laptop to operate at a certain power level, e.g. wake, standby, hibernate, or the like. Here, the control point power management signal directs the laptop to operate at a wake power state.

At 440, the network power manager receives the control point power management signal. At 442, the network power manager issues a command to local power manager 224 to switch the power managed device to the directed power state, which may be higher or lower than a current power state. In the present example, the local power manager switches the power managed device to a wake state. When the power managed device switches state, it transmits an event notification at 414. This event notification is received by the control point at 416.

In certain applications, at 444, in response to the event notification, an alert is sent to media request manager 320 to inform the media request manager that the device is awake and to trigger a request from the manager to the device for the data at 426. The process then continues to 428, 430, 432 and 434 as previously described.

In certain applications, after the control point transmits the control point power management signal at 438, the control point initiates the timer at 442. As suggested above, in certain applications, the timer initiates a countdown to determine if any signal has returned from the power managed device. In certain configurations, if the timer times out, at 448, the control point transmits an indication to the requestor that the requested data is unavailable. The process shown in FIG. 4B stops until another event notification is transmitted at 414 or another request for data is received at 422.

In certain applications, as suggested above, the timer also determines when a threshold time limit is reached. For example, in one application, the power management information stored in 314 indicates that the power managed device takes approximately five seconds to wake from a sleep state once a directed to wake. Accordingly, in one application, the timer initiates a five second countdown. After the countdown is complete, the media request manager in control point 150 transmits the request for the data at 426. Again, this countdown may be used by a device (e.g. the television) to inform an end-user of a reason for a delayed response, a progress of the request, and/or of an expected response time.

In certain applications, after the control point determines that the power managed device is in reduced power state, the control point checks index 316 to determine if the requested data is available on another device in the network. If the data is not available in another device, then the control point proceeds to retrieve the power management information for the power managed device at 436, e.g. the wake up pattern. If, however, the data is available on another device, then, at 452, control point 150 attempts to retrieve the data from the other device. Accordingly, power managed devices which are in a sleep state can remain in the reduced power state when the data is available from another device that is already awake. At 452, the data is retrieved from the other device and, at 434, the data is transmitted to the requestor.

As indicated above, although in the present example, the control point power management signal is used direct the power managed device to wake, the signal may be used in other instances to direct the power managed device to operate at any power state. For example, in one application, the control point receives an event notification indicating that the alarm system is low on batteries. In one configuration, the control point transmits a signal directing the alarm system to enter into a low power state. In one configuration, the control point transmits a signal directing shut off during certain hours of the day. Both these signals allow the alarm system to conserve power until a user is able to replace the batteries. Thus, the control system may direct the device to operate at an increased power state or at a lower power state.

In certain applications, when a request for data is received at the control point device at 422, rather than attempting to retrieve the requested data, the control point informs the source of the request (i.e. the requestor) of the power state of the device at 454. For example, the control point may use display 360 (or another display on another device) to display to a user availability of the power managed device based on the stored indicator. In certain applications, to display ability, the user interface is configured to update a listing of devices and their power states whenever a listed device changes power states. In certain applications, to display ability, the user interface is configured to provide the user with feedback during a power state change, e.g. a “Please wait” message or a countdown of a device waking.

The control point may additionally or alternatively inform the requestor of additional information to allow the requestor itself to direct the power managed device to be a certain power state. For example, a control point in a DMA may inform a laptop of a number of network interfaces in a desktop computer, a type of each network interfaces, and an address configured on each of the network interfaces, a wake up pattern or a unique device identifier for the desktop computer. The laptop may then directly instruct the desktop computer to wake, bypassing the DMA. Thus, a system and method for managing power of network devices is disclosed.

Although of the present invention is described herein with reference to specific preferred embodiments, many modifications and variations therein would readily occur to those with ordinary skill in the art. Accordingly, all such variations and modifications are included within the intended scope of embodiments of the present invention as defined by the following claims.

Moreover, non-dependent acts may be performed in parallel. The examples were chosen and described in order to best explain the principles of embodiments of the invention and its practical applications, to thereby enable others skilled in the art to best utilize embodiments of the invention with various modifications as are suited to the particular use contemplated.

We claim:

1. A machine-readable medium having stored thereon a set of instructions, which when executed by a processor on a power-managed device, cause the processor to perform a method comprising of:
advertising to one or more control points a network power management service running on the device, the one or more control points connected to the device via a network;
subscribing at least one of the control points to the service to receive event notifications;
transmitting to a subscribed control point information to enable the subscribed control point to direct the device to operate at a certain power state;
transmitting to the subscribed control point an event notification notifying the control point of a power state of the device; and
following the event notification, receiving from the control point a signal directing the device to operate at the certain power state.

2. The machine-readable medium of claim 1, wherein the power state is a pending power state selected from the group consisting of: standby, soft off, hibernate, and low battery.

3. The machine-readable medium of claim 1, wherein the power state is a resumed power state.

4. The machine-readable medium of claim 1, wherein the device supports greater than two power states.

5. A control point device comprising:
a network interface through which to communicate with one or more power managed devices over a network, at least one power managed device running a network power management service;
a processor; and
a memory storing instructions which, when executed by the processor, cause the system to perform a set of operations, including:
identifying the power managed device running the network power management service;
subscribing to the service to receive event notifications from the power managed device;
receiving from the power managed device an event notification notifying of a power state of the power managed device; and
storing an indicator of the pending power state of the power managed device.

6. The control point device of claim 5, wherein the set of operations further include:
receiving from the power managed device information enabling the control point device to direct the power managed device to operate at a certain power state; and
based on the information and the stored indicator, transmitting a signal to the power managed device directing the power managed device to operate at the certain power state.

7. The control point device of claim 6, wherein the signal is transmitted in response to receiving a request from another device for data stored in the power managed device.

8. The control point device of claim 5, wherein the set of operations further include:
receiving a request for data stored in the power managed device; and
based on the stored indicator, retrieving the data from an alternate device.

9. The control point device of claim 5, wherein the set of operations further include:
receiving a request for data stored in the power managed device; and
in response to the request, based on the stored indicator, informing a source of the request of at least one of: a current power state of the power managed device, a number of network interfaces in the power managed device, a type of each of the network interfaces, an address configured on each of the network interfaces, a wake up pattern, and a unique device identifier.

10. The control point device of claim 5, further comprising:
a display to display to a user availability of the power managed device based on the stored indicator.

11. The control point device of claim 5, further comprising:
an alert system to alert a user of the power state of the power managed device.

12. A power managed device comprising:
a network interface through which to communicate with one or more control point devices;
a data provider connected to the network interface to provide data to the one or more control point devices when the power managed device is in a wake power state;
a local power manager connected to a power supply to switch the power managed device between the wake power state and at least one reduced power state; and
a network power manager connected to the network interface and the local power manager including:
an advertiser to advertise to the one or more control point devices a network power management service operating on the power managed device;
a subscriber to subscribe at least one of the control point devices to the advertised service;
an information transmitter to transmit to a subscribed control point device information enabling the subscribed control point device to direct the local power manager to switch the power managed device from a reduced power state to the wake power state;
an event notifier to notify the subscribed control point device of a pending switch to the reduced power state or a completed switch from the reduced power state to the wake power state;
a receiver to receive from the subscribed control point device a signal directing the local power manager to switch the power managed device from the reduced power state to the wake power state.

13. The power-managed device of claim 12, wherein the pending switch is from the wake power state to the reduced power state.

14. The power-managed device of claim 12, wherein the pending switch is from the reduced power state to another reduced power state.

15. The power-managed device of claim 12, wherein the data provider is selected from the group consisting of: a camera lens, a sensor, a storage medium, and an interface to a storage system.

16. A method for transferring data from a power managed device comprising:
remotely monitoring a power state of a power managed device based on event notifications transmitted from the power managed device indicating changes in power state;
receiving a request for data stored in the power managed device;
determining if the power managed device is in a reduced power state;
if the power managed device is in the reduced power state, transmitting a signal to wake the power managed device; and
transmitting the data from the awake power managed device in response to the request.

17. The method of claim 16, wherein the remote monitoring is over a home network.

18. The method of claim 16, further comprising:
prior to transmitting the data from the awake power managed device, receiving an event notification from the power managed device indicating the power managed device is awake.

19. The method of claim 16, further comprising:
initiating a timer upon transmitting the wake signal; and
if the timer reaches a predetermined value before receiving an event notification indicating the power managed device is awake, indicating unavailability of the power managed device in response to the request.

20. The method of claim 16, further comprising:
in response to the request, communicating with a proxy to determine if the data is stored on the device before transmitting the wake signal.
